(19) United States
(12) Patent Application Publication
(10) Pub. No.: US 2025/0121536 A1
(43) Pub. Date: Apr. 17, 2025

(54) THERMALLY CONDUCTIVE INTERFACE DEVICE

(71) Applicant: Fenner, Inc., Lititz, PA (US)

(72) Inventors: Omkar Nene, Lincoln (GB); Sammi Hassan, Lincoln (GB); Mark Wilkinson, Lincoln (GB)

(21) Appl. No.: 18/914,389

(22) Filed: Oct. 14, 2024

Related U.S. Application Data
(60) Provisional application No. 63/590,118, filed on Oct. 13, 2023.

(51) Int. Cl. B29C 43/00; B29K 83/00; B29K 105/24; B29K 509/04; B29L 31/34

(52) U.S. Cl. CPC B29C 43/003; B29K 2083/00; B29K 2105/24; B29K 2509/04; B29L 2031/3468

(57) ABSTRACT

A thermally conductive interface device produced from a thermally conductive interface material is disclosed. The device may be employed in a battery system of an electric or hybrid vehicle. The thermally conductive interface material comprises a composition of at least one silicone base, at least one inorganic filler, at least one silicone oil, a least one peroxide cross-linking agent, and/or at least one of a flame retardant and a colorant. The inorganic fillers and/or the silicone oils may be functionalized or non-functionalized. The silicone base may be a high consistency rubber (HCR) silicone.

### CROSS-REFERENCE TO RELATED APPLICATION

This application claims the benefit of U.S. Provisional Patent Application Ser. No. 63/590,118, filed Oct. 13, 2023, the entirety of which is herein incorporated by reference.

### FIELD

The disclosure relates to an interface device, and more particularly to a thermally conductive interface device.

### BACKGROUND

An electric vehicle uses one or more electric motors powered by electrical energy stored in a rechargeable battery pack. Lithium-based batteries are often chosen for their high power and energy density. To ensure that an electric vehicle operates efficiently and safely, the temperature of the battery pack must be maintained within a defined range of optimal temperatures.

As the popularity of electric vehicles increases, efficiency in the manufacturing process will become more important. Processes and devices that decrease the cost of manufacturing battery packs while simultaneously increasing their reliability and safety will be key to meeting customer demands. Specifically, there is a need for processes and devices that ensure reliable electrical connections between individual battery cells, that efficiently cool the battery pack, and that aid in the manufacturing process of assembling the thousands of individual battery cells into modular packs that can be installed and replaced when necessary.

The current requirement from the marketplace is a thermally conductive interface device that is cost effective, light weight, low specific gravity, low hardness, high compression set resistance, flame retardant, high thermal conductivity, and high electrical insulation. Conventional thermally conductive interface devices, however, have not managed to achieve this rigorous specification with thermally conductive fillers. Loading with fillers to increase thermal conductivity can have a negative impact on some of the aforementioned properties. Current thermally conductive interface devices tend to have low electrical insulation and low compression set resistance and high specific gravity.

Accordingly, it would be desirable to produce a thermally conductive interface device, wherein a complexity, weight, and cost thereof are minimized, while optimizing a performance and function.

### SUMMARY

In concordance and agreement with the presently described subject matter, a thermally conductive interface device, wherein a complexity, weight, and cost thereof are minimized, while optimizing a performance and function, has been newly designed.

In one embodiment, a thermally conductive interface material, comprises: at least one silicone base; one or more inorganic fillers; and at least one silicone oil.

As aspects of some embodiments, the thermally conductive interface material further comprises a peroxide cross-linking agent.

As aspects of some embodiments, the thermally conductive interface material further comprises a flame retardant.

As aspects of some embodiments, an amount of the flame retardant is in a range of about 0.0-3.0 parts per hundred rubber.

As aspects of some embodiments, the thermally conductive interface material further comprises a colorant.

As aspects of some embodiments, an amount of the flame retardant is in a range of about 0.0-5.0 parts per hundred rubber.

As aspects of some embodiments, the silicone base is a high consistency rubber silicone.

As aspects of some embodiments, an amount of the at least one silicone base is in a range of about 40-80 parts per hundred rubber.

As aspects of some embodiments, one of the one or more inorganic fillers is an alumina.

As aspects of some embodiments, the alumina is in a range of about 0.1% volume to about 70% volume.

As aspects of some embodiments, one of the one or more inorganic fillers is a boron nitride.

As aspects of some embodiments, the boron nitride is in a range of about 0.1% volume to about 45% volume.

As aspects of some embodiments, a size of the boron nitride is about 15 to about 220 microns.

As aspects of some embodiments, the one or more inorganic fillers is functionalized and/or non-functionalized.

As aspects of some embodiments, an amount of the at least one silicone oil is in a range of about 20-60 parts per hundred rubber.

As aspects of some embodiments, at least one silicone oil is a mixture of dimethyl silicone oil and methyl vinyl silicone oil.

As aspects of some embodiments, the at least one silicone base is a high consistency rubber silicone in an amount of about 50-70 parts per hundred rubber, the one or more inorganic fillers are an alumina in an amount of about 40-60% volume and a boron nitride in an amount of about 5-20% volume, and the at least one silicone oil is a mixture of a methyl silicone oil in an amount of about 30-45 parts per hundred rubber and a methyl vinyl silicone oil in an amount of about 0.1-15 parts per hundred rubber.

In another embodiment, a method, comprises: producing a thermally conductive interface material from a composition comprising at least one silicone base, one or more inorganic fillers, and at least one silicone oil; and forming the thermally conductive interface material into the thermally conductive interface device.

As aspects of some embodiments, a high-temperature vulcanization compression molding process is used to form the thermally conductive interface device from the thermally conductive interface material.

As aspects of some embodiments, the method further comprises disposing the thermally conductive interface device into a battery system.

Further areas of applicability will become apparent from the description provided herein. The description and specific examples in this summary are intended for purposes of illustration only and are not intended to limit the scope of the present disclosure.

### DESCRIPTION OF DRAWINGS

The drawings described herein are for illustrative purposes only of selected embodiments and not all possible implementations, and are not intended to limit the scope of the present disclosure.

FIG. 1 is a schematic perspective view of a thermally conductive interface device produced from a thermally conductive interface material according to an embodiment of the present disclosure;

FIG. 2 is a process flow diagram of a method of manufacturing the device of FIG. 1; and

FIG. 3 is a schematic perspective view of an exemplary electric vehicle including a battery system having a plurality of battery packs, wherein the device of FIG. 1 is employed therein.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by parts per hundred rubber (phr) and by volume of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, volume percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

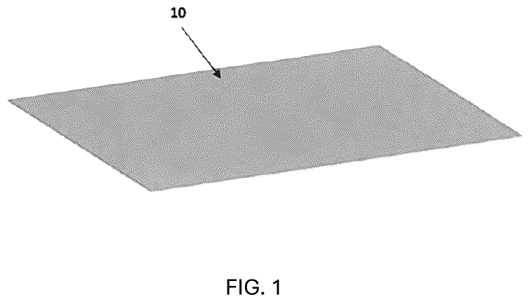

FIG. 1 illustrates a thermally conductive interface device 10. The device 10 may be configured to transfer thermal energy from heat generating components to heat sinks and/or cooling devices. In an exemplary embodiment, the device 10 may be a sheet or pad that can conform to a variety of surfaces and substrates to improve thermal performance. It is understood, however, that the device 10 may have any suitable size, shape, and configuration as necessary for use in various applications.

The device 10 is produced from a thermally conductive interface material. In preferred embodiments, the thermally conductive interface material is comprised of at least one of a silicone base, a combination of inorganic fillers including but not limited to alumina and/or boron nitride, one or more silicone oils, and a peroxide cross-linking agent. In some embodiments, the thermally conductive interface material may further comprise one or more flame retardants and/or one or more colorants. It should also be appreciated that in various embodiments the boron nitride, the alumina, and/or the silicone oil may be functionalized and/or non-functionalized, if desired.

In certain embodiments, the silicone base may be a high consistency rubber (HCR) silicone, which has outstanding properties and are far superior to conventional organic elastomers. The HCR silicones exhibit exceptional mechanical strength over a wide temperature range and can be used at temperatures from −50° C. to over 300° C. In addition to thermal resistance, HCR silicones offer flexibility for added properties such as good dielectric strength, low flammability and chemical resistance. Additionally, the functionalized boron nitride, the functionalized alumina, and/or the functionalized silicone oil provides improved flexibility around tailoring the properties of the thermally conductive interface material for various applications.

In some embodiments, a composition of the thermally conductive interface material may be adjusted so that one or more surfaces of the device 10 permit and/or enhance attachment and/or maintain a position thereof relative to adjacent surfaces or substrates. For example, the composition of the thermally conductive interface material may such to produce a device 10 having relatively tacky or sticky surfaces.

In some embodiments, the thermally conductive interface material may be a composition comprising the HCR silicone base in a range of about 40-80 parts per hundred rubber (phr), silicone oil in a range of about 20-60 phr (wherein the silicone oil is a combination of dimethyl silicone oil and methyl vinyl silicone oil), alumina in a range of about 0.1% to about 70% volume, and boron nitride in a range of about 0.1% to about 45% volume. The size of the boron nitride may vary from about 15 to about 220 microns or more. Morphology may vary from platelets, flakes, and agglomerates. As described hereinabove, one or more of the boron nitride and the alumina may be functionalized or non-functionalized. A flame retardant and/or a colorant may also be added to the composition of the thermally conductive interface material. In a non-limiting example, the flame retardant may be in a range of about 0.0-3.0 phr and/or the colorant may be in a range of about 0.0-5.0 phr.

In other embodiments, the thermally conductive interface material may be a composition comprising the HCR silicone base in a range of about 40-80 phr, silicone oil in a range of about 20-60 phr (wherein the silicone oil is a combination of dimethyl silicone oil and methyl vinyl silicone oil), alumina in a range of about 35% to about 58% volume, and boron nitride in a range of about 2.5% to about 20% volume. The size of the boron nitride may vary from about 15 to about 120 microns or more. Morphology may vary from platelets, flakes, and agglomerates. One or more of the boron nitride and the alumina may be functionalized or non-functionalized. A flame retardant and/or a colorant may also be added to the composition of the thermally conductive interface material. In a non-limiting example, the flame retardant may be in a range of about 0.0-3.0 phr and/or the colorant may be in a range of about 0.0-5.0 phr.

In certain preferred embodiments, the thermally conductive interface material comprises about 50 to 70 phr of the HCR silicone base, about 30 to 45 phr of the methyl silicone oil, about 0.1 to 15 phr of the methyl vinyl silicone oil, about 40 to 60% volume of the alumina, and about 5 to 25% volume of the boron nitride.

In other preferred embodiments, the thermally conductive interface material comprises about 55 to 65 phr of the HCR silicone base, about 30 to 39 phr of the methyl silicone oil, about 1 to 10 phr of the methyl vinyl silicone oil, about 40 to 50% volume of the alumina, and about 5 to 15% volume of the boron nitride.

In another preferred embodiment, the thermally conductive interface material offers high performance in thermal conductivity, dielectric strength, and compression set resistance, and comprises about 55 to 65 phr of the HCR silicone base, about 35 to 40 phr of the methyl silicone oil, about 1 to 5 phr of the methyl vinyl silicone oil, about 45 to 55% volume of the alumina, and about 10 to 20% volume of the boron nitride.

Alternatively, when desired in specific applications, the thermally conductive interface material may comprised of about 55 to 60 phr of the HCR silicone base, about 40 to 45 phr of the methyl silicone oil, about 0.1 to 0.9 phr of the methyl vinyl silicone oil, about 40 to 45% volume of the alumina, and about 5 to 10% volume of the boron nitride, which lowers performance in thermal conductivity, dielectric strength and compression set resistance as compared to the preferred embodiments.

Such thermally conductive interface material of each of the embodiments may further comprise the flame retardant and/or the colorant.

It should be understood that changes, modifications and variations to the materials and compositions thereof for each of the embodiments described herein can be made within the scope of the present technology, with substantially similar results.

A performance of the device 10 produced from the thermally conductive interface material is exhibited in Table 1 below.

TABLE 1
Performance

| Property | Range |
|---|---|
| Thermal Conductivity (W/m · K) | >0.1 |
| Durometer Shore A | <70 |
| Compression Set % | <30 |
| Specific Gravity (g/cm³) | <3.0 |
| Dielectric Strength (kV/mm) | >5 |

A performance of the device 10 produced from the thermally conductive interface material in accordance with various embodiments of the present disclosure is exhibited in Table 2 below.

TABLE 2
Performance of Exemplary Embodiment

| Property | Range |
|---|---|
| Thermal Conductivity (W/m · K) | 0.1-4.0 |
| Durometer Shore A | 20-70 |
| Compression Set % | 5-30 |
| Specific Gravity (g/cm³) | 1.4-3.0 |
| Dielectric Strength (kV/mm) | 5-25 |

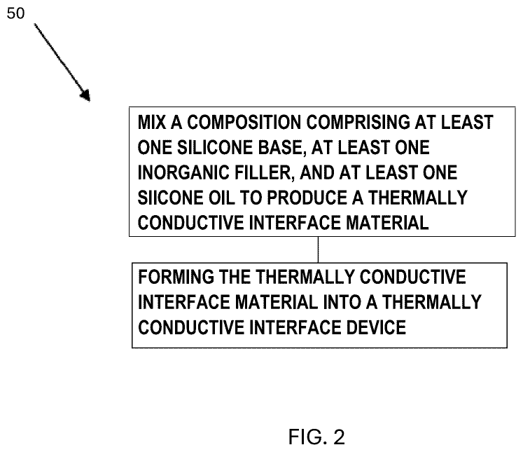

A method 50 (shown in FIG. 2) of producing the device 10 from the thermally conductive interface material according to an embodiment of the present disclosure may comprise the steps of: (1) mixing a composition of the silicone base, the pretreated inorganic thermally conductive fillers including the alumina and the boron nitride, the silicone oils, the cross-linking agent, and, if any, the flame retardant and/or the colorant together using a kneading machine operating at a desire rate (e.g., between about 15 and about 75 revolutions per minute) to produce the thermally conductive interface material; and (2) forming the thermally conductive interface material into the device 10 by thinly passing the thermally conductive interface material on an open mill and using high-temperature vulcanization compression molding to produce the device 10.

It is understood that other methods of manufacturing the device 10 may be employed such as compression molding under heat and/or pressure, injection molding, calendaring into roll form, extrusion molding, and the like, for example. Various other suitable methods, process, and combinations thereof may be employed to produce the thermally conductive interface material and/or the device 10 manufactured therefrom.

In other embodiments, the device 10 may further include at least one adhesive layer disposed on one or more surfaces thereof to permit and/or enhance attachment and/or maintain a position of the device 10 relative to adjacent surfaces or substrates. It is understood that any suitable type of adhesive may be employed to achieve desired results.

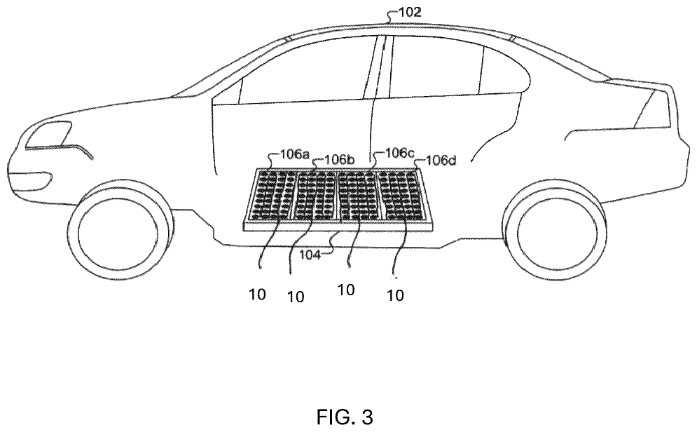

FIG. 3 illustrates a simplified diagram 100 of an electric or hybrid vehicle 102 with a rechargeable battery system 104, according to some embodiments. Depending on the embodiment, the electric vehicle 102 may include hybrid vehicles that operate using both fuel combustion and stored electric power, as well as fully electric vehicles that operate entirely from stored electric power.

The rechargeable battery system 104 may be comprised of one or more battery packs 106. The battery pack 106 may be comprised of a plurality of individual battery cells that are electrically connected to provide a particular voltage/current to the electric vehicle 102. As used herein, the terms “battery”, “cell”, and “battery cell” may be used interchangeably to refer to any type of individual battery element used in a battery system. The batteries described herein typically include lithium-based batteries, but may also include various chemistries and configurations including iron phosphate, metal oxide, lithium-ion polymer, nickel metal hydride, nickel cadmium, nickel-based batteries (hydrogen, zinc, cadmium, etc.), and any other battery type compatible with an electric vehicle.

The rechargeable battery system 104 represents a major component of the electric vehicle 102 in terms of size, weight, and cost. A great deal of effort goes into the design and shape of the rechargeable battery system 104 in order to minimize the amount of space used in the electric vehicle 102 while ensuring the safety of its passengers. In some electric vehicles, the rechargeable battery system 104 is located under the floor of the passenger compartment as depicted in FIG. 1. In other electric vehicles, the rechargeable battery system 104 can be located in the trunk or in the hood areas of the electric vehicle.

Each battery pack 106 may include a large number of individual battery cells. In one embodiment, a plurality of individual lithium-ion batteries are joined together to form a single battery pack 106, and the rechargeable battery system 104 may include, for example, four battery packs 106a, 106b, 106c, 106d, eight battery packs, ten battery packs, sixteen battery packs, and/or the like, connected in parallel or series until the electrical requirements of the electric vehicle 102 are satisfied. The individual battery cells included in each battery pack 106 may total in the thousands for a single electric vehicle 102.

The battery pack 106 may also be in communication with a heat exchanger, heat sink, and/or other cooling device via a cooling loop. It will be understood that actual battery packs 106 may include many more individual battery cells and more complicated routing of the coolant loop.

The individual battery cells in the battery pack 106 may be linearly arranged in a series of rows, with each individual battery cell being adjacent to another battery cell within the row. In some embodiments, there will be no appreciable gap between the individual battery cells within a single row. The battery pack 106 may include pairs of adjacent rows separated by the coolant loop. The electric vehicle 102 may be configured to pump liquid coolant through the coolant loop in order to transfer heat from the battery pack 106 to the heat exchanger, heat sink, and/or other cooling device. The coolant loop may include one or more coolant tubes through which liquid coolant may be circulated. In some embodiments, the electric vehicle 102 may use a dedicated coolant loop for the battery pack 106, while other embodiments may utilize an existing engine coolant system. In some embodiments, the coolant loop may also be coupled to a heating system, such that the battery pack 106 can be heated when extreme weather causes the ambient temperature to drop below a preferred operating temperature range of the individual battery cells.

In some embodiments, a device 10 may be disposed between the coolant loop and a first row of the battery cells. In other embodiments, another device 10 may also be applied between the coolant loop and a second row of the battery cells. The device 10 may have a first side that is configured to conform to the coolant loop and/or a second side configured to conform to one of the rows of the battery cells. The device 10 may perform as a thermal conductor. In embodiments without the cooling loop, the device 10 may be disposed between adjacent battery cells of the battery packs 106.

Advantageously, the device 10 provides superior thermal technology to the emerging electric vehicle industry. The device 10 is more sustainable than the current solution of gels and liquids in terms of reusability. For example, the device 10 can be easily removed from a damaged battery pack 106 and reused with a reconditioned or new battery pack 106, if desired. Additionally, the device 10 has improved function and performance over conventional thermal pads as well as the ability to significantly reduce a cycle time of manufacturing the battery pack 106.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A thermally conductive interface material, comprising:
at least one silicone base;
one or more inorganic fillers; and
at least one silicone oil.

2. The thermally conductive interface material of claim 1, further comprising a peroxide cross-linking agent.

3. The thermally conductive interface material of claim 1, further comprising a flame retardant.

4. The thermally conductive interface material of claim 3, wherein an amount of the flame retardant is in a range of about 0.0-3.0 parts per hundred rubber.

5. The thermally conductive interface material of claim 1, further comprising a colorant.

6. The thermally conductive interface material of claim 5, wherein an amount of the flame retardant is in a range of about 0.0-5.0 parts per hundred rubber.

7. The thermally conductive interface material of claim 1, wherein the silicone base is a high consistency rubber silicone.

8. The thermally conductive interface material of claim 1, wherein an amount of the at least one silicone base is in a range of about 40-80 parts per hundred rubber.

9. The thermally conductive interface material of claim 1, wherein one of the one or more inorganic fillers is an alumina.

10. The thermally conductive interface material of claim 9, wherein the alumina is in a range of about 0.1% volume to about 70% volume.

11. The thermally conductive interface material of claim 1, wherein one of the one or more inorganic fillers is a boron nitride.

12. The thermally conductive interface material of claim 11, wherein the boron nitride is in a range of about 0.1% volume to about 45% volume.

13. The thermally conductive interface material of claim 11, wherein a size of the boron nitride is about 15 to about 220 microns.

14. The thermally conductive interface material of claim 1, wherein the one or more inorganic fillers is functionalized and/or non-functionalized.

15. The thermally conductive interface material of claim 1, wherein an amount of the at least one silicone oil is in a range of about 20-60 parts per hundred rubber.

16. The thermally conductive interface material of claim 1, wherein the at least one silicone oil is a mixture of dimethyl silicone oil and methyl vinyl silicone oil.

17. The thermally conductive interface material of claim 1, wherein the at least one silicone base is a high consistency rubber silicone in an amount of about 50-70 parts per hundred rubber, the one or more inorganic fillers are an alumina in an amount of about 40-60% volume and a boron nitride in an amount of about 5-20% volume, and the at least one silicone oil is a mixture of a methyl silicone oil in an amount of about 30-45 parts per hundred rubber and a methyl vinyl silicone oil in an amount of about 0.1-15 parts per hundred rubber.

18. A method, comprising:
producing a thermally conductive interface material from a composition comprising at least one silicone base, one or more inorganic fillers, and at least one silicone oil; and
forming the thermally conductive interface material into the thermally conductive interface device.

19. The method of claim 18, wherein a high-temperature vulcanization compression molding process is used to form the thermally conductive interface device from the thermally conductive interface material.

20. The method of claim 18, further comprising disposing the thermally conductive interface device into a battery system.
